(19) United States
(12) Patent Application Publication
(10) Pub. No.: US 2020/0153904 A1
(43) Pub. Date: May 14, 2020

(54) WIRELESS SENSOR SIGNAL PROCESSING SYSTEM AND WIRELESS SENSOR SIGNAL PROCESSING METHOD THEREOF

(71) Applicant: Cheol Yong YOO, Seoul (KR)

(72) Inventor: Cheol Yong YOO, Seoul (KR)

(21) Appl. No.: 16/609,725

(22) PCT Filed: Aug. 2, 2018
(86) PCT No.: PCT/KR2018/008806

§ 371 Date: Oct. 30, 2019

(30) Foreign Application Priority Data
Aug. 3, 2017 (KR) 10-2017-0098396

(51) Int. Cl. H04L 29/08; H04W 4/80; H04W 84/18; H04W 12/06; H04W 4/06; H04L 29/06

(52) U.S. Cl. CPC H04L 67/12; H04W 4/80; H04W 84/18; H04Q 2209/883; H04W 4/06; H04L 63/0861; H04Q 2209/40; H04W 12/06

(57) ABSTRACT

The present invention relates to a wireless sensor signal processing system comprising: a plurality of wireless sensors for simultaneously transmitting a sensor signal sensing a measurement target to two or more terminal devices within a transmission range in the same protocol to allow simultaneous channel switch; and the two or more terminal devices for simultaneously receiving the sensor signal, processing and outputting the sensor signal only in an activated state, and not outputting the received sensor signal in a deactivated state, wherein activation and deactivation of the terminal devices is performed according to information on approach of a user to the terminal devices or an event signal generated by a user authentication means.

### TECHNICAL FIELD

The present invention relates to a low-power ultralight wireless sensor, a wireless sensor signal processing system for processing signals with the wireless sensor, and a wireless sensor signal processing method thereof, and more specifically, to a wireless sensor signal processing system and a wireless sensor signal processing method thereof, which are configured to synchronize wireless sensor signals sensed by a plurality of wireless sensors to allow simultaneous channel switch of the wireless sensors when an event signal of selecting a specific terminal device is generated, and allow only an activated terminal device to process the wireless sensor signals.

### BACKGROUND ART

A wireless sensor is a device for sensing information at a position contacting with or close to a measurement target and transferring the information to various data processing devices such as a terminal device.

Wireless sensors like this are continuously developed according to advancement in techniques such as integration technique, low-power design, signal processing, and wireless communication of electronic components.

Particularly, since sensing techniques for health monitoring are developed as the interest in health grows, an environment capable of measuring health conditions anytime and anywhere is created.

In addition, wireless sensors sensing biometric information (or body information) are designed in a variety of shapes and sizes, and recently, they are developed in a miniaturized form of a nano type that can be attached to or transplanted in a part of a body, getting out of the range of generally carried.

The range of utilizing or applying the wireless sensors is endless.

As the biometric information is sensed like this and transferred to a clinic system, health status of an individual may be continuously checked, and the biometric information may be displayed to be confirmed by a user in real-time. For example, when an abnormal phenomenon occurs in the body, a corresponding wireless sensor senses and informs the abnormal phenomenon to various terminal devices, together with information on pulse, respiration, blood pressure, blood flow rate, brainwave, temperature and humidity of skin, fatigue of muscles and the like, and the user may properly adjust the exercise amount to be suitable for his or her current biological rhythm.

Miniaturization is the key point in using the various wireless sensors described above, and a technique of integrating electronic components and a low power technique for reducing a battery size are required for miniaturization. As the technique of integrating electronic components is much progressed owing to development of techniques, chip sensors of a micro size can be manufactured. However, the low power technique is still insufficient for miniaturization in many cases, and the duration of time of using the battery is still not long enough as to be satisfied. Accordingly, securing the low power techniques is much more important.

That is, artificial organs or wireless sensors transplanted in a body have a problem of replacing a battery with a new one in a method such as an operation or the like when the battery is drained out, and therefore, required is an improved low power technique capable of extending the use time by reducing consumption of the battery.

FIG. 1 is a view showing that a user embedded with various wireless sensors (hereinafter, devices such as a biosensor, an artificial organ, a nano-robot and the like are referred to as a “wireless sensor”) may selectively send wireless sensor signals sensed by the wireless sensor to various terminal devices. To implement FIG. 1, simultaneous channel switch should be allowed by matching the protocols of the wireless sensors in the body of the user, and miniaturization of a battery should be possible through construction of a low power environment.

However, the above problems cannot be solved by the connection methods between terminals of Bluetooth or other wireless communication specifications. It is since that when a wireless biosensor switches a channel to a selected terminal device among a plurality of terminal devices, each wireless sensor should be embedded with a reception unit for sensing the channel switch to solve the pairing problem required each time, and power of the reception unit should be turned on at all times, and thus there is a problem of consuming too much power of the battery installed in the wireless sensor. That is, if it is assumed that the wireless sensor is continuously supplied with power while a reception unit is embedded to sense channel switch, it is difficult to supply power more than 12 hours with a battery of an ordinary size embedded in the wireless sensor, and this problem practically invites a problem of lowering marketability of the wireless sensor.

### DISCLOSURE OF INVENTION

### Technical Problem

Therefore, the present invention has been made in view of the above problems, and it is an object of the present invention to provide a system for processing signals of a wireless sensor configured to allow simultaneous channel switch of wireless sensors by excluding configuration of a reception unit provided in the wireless sensor and matching the protocols of all wireless sensors.

Another object of the present invention is to provide a wireless sensor signal processing system and a method thereof, in which as a process of opening and closing an intercommunication path between each terminal device and a corresponding reception module (hereinafter, named as a “receiver”) by a specific signal is provided, a terminal device selected by the specific signal may output a received wireless sensor signal as the intercommunication path is opened, and a terminal device that is not selected may not output a received wireless sensor signal as the intercommunication path is closed.

Still another object of the present invention is to provide a wireless sensor signal processing system and a method thereof, in which a terminal device that is not selected, other than the selected terminal device, reconfirms to continuously maintain the closed state of the intercommunication path connected to a corresponding receiver, and although a wireless sensor signal is transmitted from a wireless sensor, the receiver only receives the signal, but ignores and does not output the signal to the terminal device that is not selected.

Since various wireless sensors may achieve simultaneous channel switch and low power consumption owing to the objects of the present invention, use time of a battery is extended, and miniaturization can be achieved.

### Technical Solution

To accomplish the above objects, according to one aspect of the present invention, there is provided a wireless sensor signal processing system comprising: a plurality of wireless sensors for simultaneously transmitting a sensor signal sensing a measurement target to two or more terminal devices within a transmission range in the same protocol to allow simultaneous channel switch; and the two or more terminal devices for simultaneously receiving the sensor signal, processing and outputting the sensor signal only in an activated state, and not outputting the received sensor signal in a deactivated state, wherein activation and deactivation of the terminal devices is performed according to information on approach of a user to the terminal devices or an event signal generated by a user authentication means.

Preferably, the wireless sensor includes: a sensing unit for sensing information on the measurement target; and a control unit for controlling the wireless sensor to transmit the sensed sensor signal to a terminal device within the transmission range, wherein the sensor signal includes an authentication message and a wireless sensor data.

In addition, preferably, the terminal device includes a receiver for receiving the sensor signal, wherein the receiver receives the event signal and activates the terminal device only when an authentication procedure of the receiver is passed.

Here, the receiver preferably includes: an approach sensing unit for sensing whether a user approaches; an authentication unit for authenticating the user; a sensor signal reception unit for receiving the sensor signal; and a receiver control unit for controlling the receiver to output the sensor signal only when the terminal device is in an activated state according to a processing result of the approach sensing unit or the authentication unit.

In addition, the receiver may further include a signal transmission unit for transmitting a deactivation signal to another terminal device by the activated terminal device.

Furthermore, preferably, the terminal device may include: an approach sensing unit for sensing whether a user approaches; an authentication unit for authenticating the user; a sensor signal reception unit for receiving the sensor signal; a receiver control unit for controlling the terminal device to process and output the sensor signal only when the terminal device is in an activated state according to a processing result of the approach sensing unit or the authentication unit; and a signal transmission unit for transmitting a deactivation signal to another terminal devices.

Here, it is preferable that the terminal device is a smart device for receiving and displaying biometric information, and the smart device is any one selected among fitness equipment, office equipment, a device for clinic systems, an Internet of Things (IoT) device, an industrial system operated by battery power, a sensor of a wearable form, a device for transmitting information, and a biosensor operating only by bio energy.

Furthermore, it is preferable that the terminal device in an activated state processes only the sensor signal transmitted from the wireless sensor of a specific user on the basis of an authentication message included in the sensor signal and does not simultaneously process sensor signals of two or more users.

According to another aspect of the present invention, there is provided a wireless sensor signal processing method comprising: a first step of simultaneously transmitting sensor signals sensed by a plurality of wireless sensors for sensing a measurement target to two or more terminal devices in the same protocol; a second step of simultaneously receiving the sensor signals and activating any one of the terminal devices, by the two or more terminal devices; and a third step of processing and outputting the sensor signal transmitted from the wireless sensor by only the activated terminal device, and only receiving and not outputting the sensor signal by the other terminal devices in a deactivated state.

Preferably, in the second step, according to a signal strength of a proximity sensor installed in the wireless sensor, a terminal device having a signal strength larger than a previously set reference value or a terminal device having a highest signal of the proximity sensor is activated, or only a terminal device having performed user authentication through an authentication means of the terminal device is activated.

In addition, the second step further includes a deactivation step of transmitting a deactivation signal to another terminal device and deactivating the terminal devices by the activated terminal device, wherein the deactivation step sequentially performs the steps of transmitting a deactivation signal to at least one other nearest terminal device by the activated terminal device, transmitting a deactivation signal to at least one other terminal device near the terminal device by the one other terminal device, and switching the terminal devices to a deactivated state after transmitting the deactivation signal.

Here, it is preferable that the activated terminal device is switched to a deactivated state when the activated terminal device goes out of a sensing range of the proximity sensor according to movement of the user.

According to still another aspect of the present invention, there is provided a wireless sensor signal processing method comprising: a first step of approaching a terminal device by a user having a wireless sensor for sensing biometric information of the user; a second step of activating the terminal device by performing user authentication through an authentication means provided in the terminal device; and a third step of processing a sensor signal transmitted from the wireless sensor by the activated terminal device. Here, the authentication means may be performed through a card recognition method or various biometric recognition methods such as iris recognition or fingerprint recognition. At this point, the activated terminal device may deactivate another terminal device by transmitting a deactivation signal.

### Advantageous Effects

According to the present invention as described above, since wireless sensor sensing predetermined information excludes configuration of a reception unit which senses channel switch, use time of a battery installed in the wireless sensor can be extended, and miniaturization of the wireless sensor can be expected.

In addition, since the sensor signal processing system is manufactured in a form matching protocols between the wireless sensors and the terminal device, a system environment, in which an infinite number of wireless sensors and terminal devices can be used, can be provided. The system environment like this allows additional setting of new wireless sensors and terminal devices.

In addition, a terminal device communicating with a wireless sensor may be activated or deactivated by an event signal generated according to approach of a user to the terminal device or an authentication procedure, and since the system provides an environment in which only an activated terminal device outputs a sensor signal, whereas a terminal device in a deactivated state does not output the sensor signal although it receives the sensor signal, channels of the overall system configuration including the wireless sensor can be efficiently managed.

### BRIEF DESCRIPTION OF THE DRAWINGS

FIG. 1 is a view showing the configuration of a sensor signal processing system configured of a plurality of wireless sensors and a plurality of terminal devices that the present invention may apply conventionally.

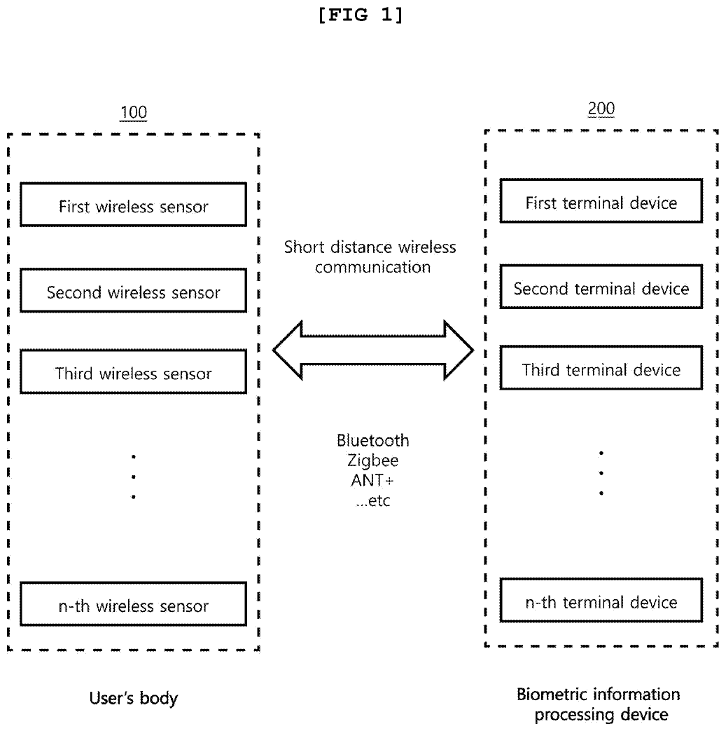

FIG. 2 is a view showing the configuration of a sensor signal processing system including a wireless sensor according to the present invention.

FIG. 3 is block diagrams showing the major components of a wireless sensor and a terminal device according to an embodiment of the present invention.

FIG. 4 is a block diagram showing the major components of a receiver according to an embodiment of the present invention.

FIG. 5 is a view illustrating a first embodiment of a method of processing sensor signals by a sensor signal processing system of the present invention.

FIG. 6 is a view illustrating a second embodiment of a method of processing sensor signals by a sensor signal processing system of the present invention.

FIG. 7 is a flowchart illustrating a method of processing sensor signals by a sensor signal processing system according to an embodiment of the present invention.

FIG. 8 is a flowchart illustrating a method of processing sensor signals by a sensor signal processing system according to another embodiment of the present invention.

### BEST MODE FOR CARRYING OUT THE INVENTION

The present invention activates a specific terminal device according card recognition, biometric recognition or a degree of close distance approach, and only the activated terminal device receives and outputs a sensor signal sensed by a wireless sensor, and the other deactivated terminal devices do not output and ignore the sensor signal although they receive the sensor signal.

In addition, the wireless sensor is a sensor transplanted in or mounted on a body and sensing biometric information of the user, and the terminal device refers to various smart devices for receiving and displaying the biometric information. Examples of the smart device may include health equipment (e.g., a treadmill), various smart electric/electronic products, office equipment, devices for clinic systems, smart TVs, smart door locks, smart phones, smart devices for Internet of Things (IoT) such as a smart band, and various industrial smart devices.

In addition, although communications between a wireless sensor and a terminal device, communications between terminal devices or the like are accomplished according to wireless communication protocols in the present invention, they are not limited to a specific communication method. Accordingly, in the present invention, the communication method may apply currently developed various next-generation communication protocols or the like, in addition to the currently used methods such as Wi-Fi, infrared data association (IRDA), Bluetooth, Zigbee, LoRA, 2.4 GHz RFID, NFC, IrDA, LTE, ANT+ and the like.

In addition, the present invention activates a specific terminal device and processes a sensor signal sensed by a wireless sensor through authentication carried out by card recognition or various biometric recognition such as iris recognition and fingerprint recognition, or through a degree of approach to a terminal device applying a proximity sensor, and embodiments thereof will be described separately.

The present invention like this may be regarded as a technique which allows miniaturization and extended use of a battery since a low power environment can be constructed when various terminal devices are selectively used in an environment of providing a plurality of wireless devices such as a wireless sensor or an artificial organ.

In addition, in describing the embodiments of the present invention, a specific signal is named as an “event signal”, a process of opening an intercommunication path between each terminal device and a corresponding receiver is named as “activation”, a process of closing the intercommunication path is named as “deactivation”, and a wireless sensor signal transmitted from each wireless sensor is named as a “sensor signal”.

Before describing the embodiments of the present invention, the wireless sensor will be described. The wireless sensor 100 may include a sensor that can be mounted on or transplanted in the body of a user, and the wireless sensor 100 may include practically all of a wireless biometric sensor, a nano sensor robot, and an artificial organ which transmits state information. In addition, the wireless sensor 100 may be a sensor used for IoT. A wireless sensor of a comparatively small size and a device for transmitting information, which are mounted on cloths, bags, shoes or the like of a wearable form and can be installed in various industrial systems operated by battery power, or developed as an accessory such as glasses, bracelets or the like and mounted on the body, may be included in the wireless sensor 100, and in addition, an extremely low power biosensor operating only by bio energy without a battery may be included.

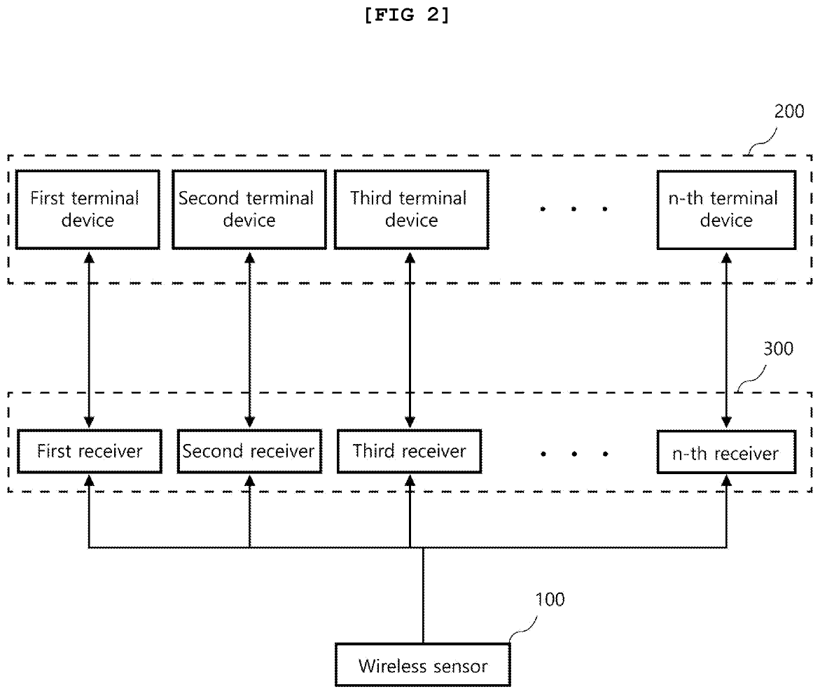

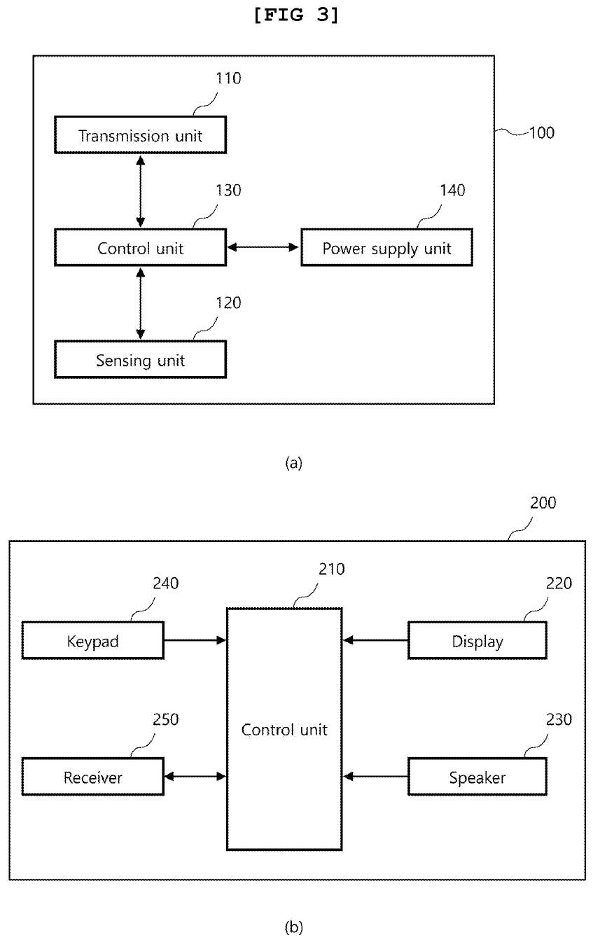

FIG. 2 is a view showing the configuration of a sensor signal processing system including a wireless sensor according to the present invention, and FIG. 3 is block diagrams showing the major components of a wireless sensor and a terminal device according to an embodiment of the present invention.

Compared with a conventional sensor signal processing system configured of a plurality of wireless sensors and a plurality of terminal devices, the present invention configures a sensor signal processing system, as shown in FIG. 2, by adding a receiver 300 displayed as a first receiver, a second receiver, a third receiver, . . . , and an n-th receiver to each of a plurality of terminal devices 200 displayed as a first terminal device, a second terminal device, a third terminal device, . . . , and an n-th terminal device.

As shown in FIG. 3(a), the wireless sensor 100 is configured to include a sensing unit 120 for sensing a measurement target, a transmission unit 110 for transferring a sensed signal to the terminal device 200, a control unit 130 for controlling overall operation of the wireless sensor 100, and a battery 140 for supplying power. In an embodiment, the wireless sensor 100 like this senses generation of an abnormal phenomenon in the body, together with information on pulse, respiration, blood pressure, blood flow rate, brainwave, temperature and humidity of skin, fatigue of muscles or the like of the user.

In addition, in an embodiment of the present invention, the wireless sensors 100 randomly transmit sensor signals of the same protocol to a plurality of terminal devices 200 (a first terminal device, a second terminal device, a third terminal device, . . . , and an n-th terminal device) as directed by the control unit 130 periodically or according to change of a situation such as occurrence of an abnormal symptom, and an environment of processing information only by a selected terminal device is constructed.

Referring to FIG. 3(b), a plurality of terminal devices 200 (a first terminal device, a second terminal device, a third terminal device, . . . , and an n-th terminal device) includes a control unit 210 for controlling the terminal device to process a sensor signal in association with the receiver 300 while performing a function of, for example, health equipment, and a display 220 for displaying various information, exercise screens, images or the like. In some cases, a speaker 230 for outputting the information as voice information may be provided. The display 220 and the speaker 230 like this output information in the form of a predetermined message by the control operation of the control unit 210, and the present invention may adopt a means of another type without limit. That is, all the devices receiving a control command of the control unit 210 and executing the command so that the user himself or herself or a third part may recognize may be included in the terminal device.

In addition, a receiver 300 (a first receiver, a second receiver, a third receiver, . . . , and an n-th receiver) is provided in each of the plurality of terminal devices 200(a first terminal device, a second terminal device, a third terminal device, . . . , and an n-th terminal device).

The receiver 300 according to the present invention accesses a specific terminal device that the user desires to use and performs an authentication procedure (i.e., reception of an event signal) and, when activation is selected among activation and deactivation according to the authentication procedure, provides a function of processing and outputting a sensor signal sensed by the wireless sensor 100. If deactivation is selected after the authentication procedure is performed, the sensor signal is not outputted to the terminal device and ignored.

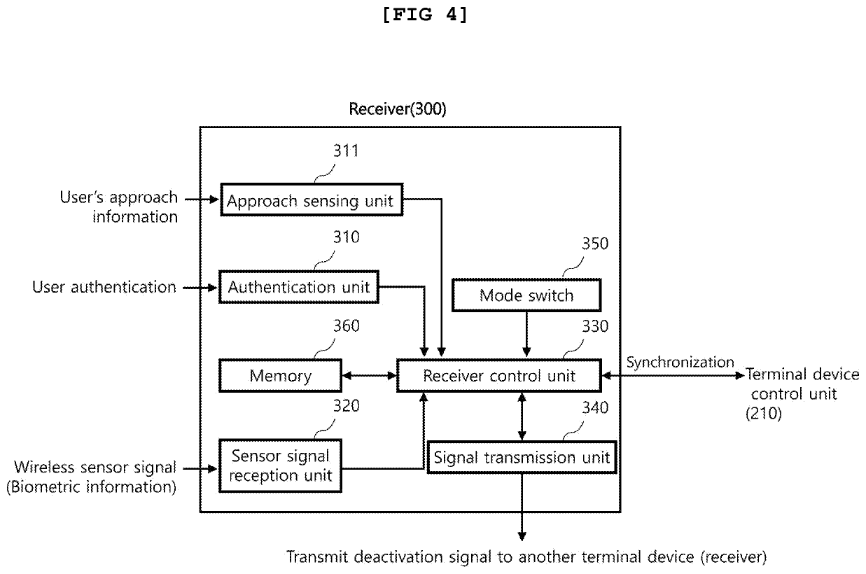

Referring to FIG. 4, the receiver 300 (a first receiver, a second receiver, a third receiver, . . . , and an n-th receiver) of this embodiment may include an authentication unit 310 for user authentication. The authentication unit 310 performs a function of determining whether or not to activate a specific terminal device by the user according to an event signal of selecting a terminal device, and diverse authentication means for user authentication may be provided. The authentication means may be, for example, a card reader for reading an ID card in a contact or non-contact method or a device capable of reading fingerprint or iris information as biometric information of the user. Of course, it is apparent that the ID card information or the biometric information for authentication should be stored in a memory 360 provided in the receiver 300.

In this embodiment, an approach sensing unit 311 for receiving a degree of approach of a proximity sensor may be provided in the receiver 300. At this point, the user carries the proximity sensor. In addition, according to the present invention, the receiver 300 may be configured to include either the authentication unit 310 or the approach sensing unit 311 or both of them.

In addition, a sensor signal reception unit 320 for receiving a sensor signal transmitted from the wireless sensor 100 is provided in the receiver 300. Here, the sensor signal includes an authentication message and a wireless sensor data (i.e., biometric information). In addition, it is not that only the reception unit of a specific receiver receives the sensor signal, but the sensor signal reception units 320 of all the receivers 300 installed in the plurality of terminal devices 200(a first terminal device, a second terminal device, a third terminal device, . . . , and an n-th terminal device) receive the sensor signal.

However, the sensor signal may be processed and outputted only by the terminal device that is activated by an event signal. Although deactivated terminal devices receive the sensor signal, they do not output and ignore the sensor signal. That is, although all the receivers receive the sensor signal, only the activated terminal device processes the sensor signal, and a state that can process the received sensor signal to be outputted is the activated state, whereas a state that does not output and ignore the received sensor signal is the deactivated state.

The receiver control unit 330 which controls the overall operation of the receiver 300 practically activates or deactivates a terminal device according to an event signal. In addition, processing and outputting a received sensor signal means that the receiver control unit 330 outputs the sensor signal as a message that can be recognized by the user or a third part, in cooperation with the terminal device control unit 210. Here, the message may be processed in the form of video and voice data, text data, an external indication lamp through the Internet or the like and outputted by setting of the user.

According to the present invention, it is known that a terminal device is activated through the authentication procedure of the authentication unit 310 or the deactivated state is maintained. However, in the present invention, a terminal device itself in an activated state may deactivate at least one other terminal device according to signal transmission between the receivers 300. This is performed by the signal transmission unit 340 provided in the receiver 300 of the terminal device.

When a terminal device, to which the receiver of the signal transmission unit 340 currently belongs, is in an activated state, the signal transmission unit 340 performs a function of transmitting a deactivation signal to deactivate a terminal device, to which another receiver belongs. In addition, the deactivation signal may be propagated through a series of processes, in which a receiver of a terminal device in an activated state transmits a deactivation signal to receivers of all the terminal devices in the neighborhood or transmits a deactivation signal to a receiver of a nearest terminal device. In addition, a terminal device receiving the deactivation signal from the receiver of the terminal device switched to the deactivated state transmits a deactivation signal to the receiver of another terminal device and switches itself to the deactivated state.

As the procedure like this is sequentially progressed, all the terminal devices except the receiver of the activated terminal device are deactivated. For reference, activating the terminal device means activating a corresponding receiver.

The signal transmission unit 340 may be selectively used. That is, when the user handles on and off of a mode switch 350, the signal transmission unit 340 may be in a state capable of transmitting a deactivation signal to another terminal device or incapable of transmitting a deactivation signal.

Meanwhile, the receiver 300 like this may be installed at a predetermined position of each of the plurality of terminal devices 200(a first terminal device, a second terminal device, a third terminal device, . . . , and an n-th terminal device) or installed in one body from the design of product.

Accordingly, the receiver 300 may be installed in the other types of devices or products, in addition to the health equipment, according to the structure, and this means that the range of utilizing the receiver 300 is wide as much. However, the receiver 300 may not be necessarily provided in the terminal device 200. It is since that the terminal device 200 may be manufactured to include all the components of the receiver 300.

Next, the signal processing method between a wireless sensor and a terminal device will be described. The signal processing method is a method of activating a terminal device, and it will be described by dividing into a first embodiment through card recognition or biometric recognition and a second embodiment using a proximity sensor.

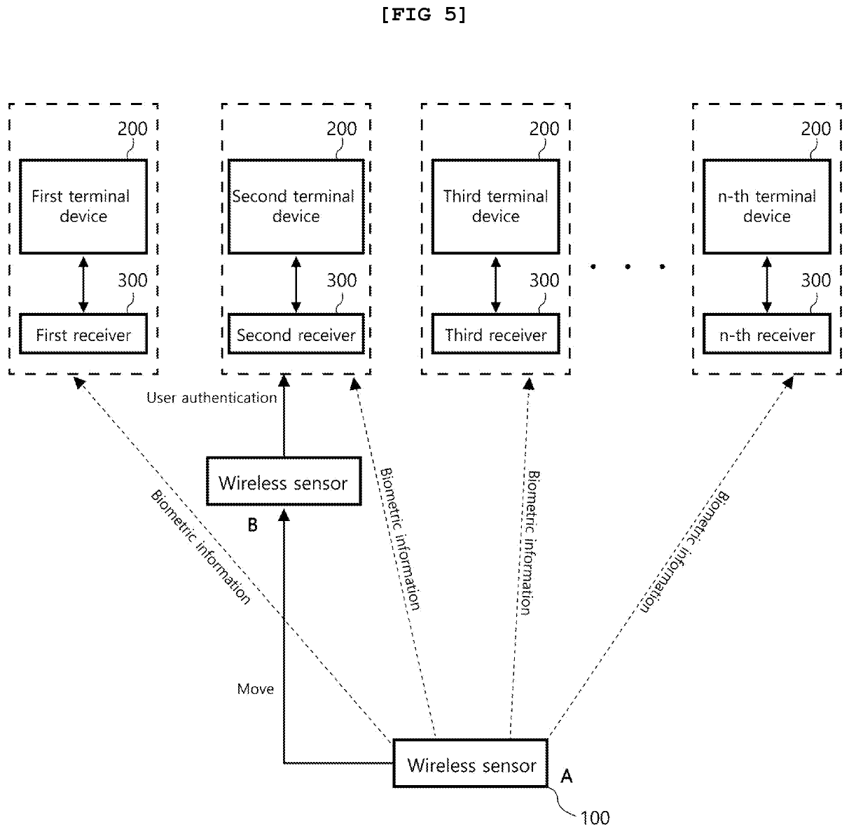

FIG. 5 is a view illustrating a first embodiment of a method of processing sensor signals by a sensor signal processing system of the present invention.

Referring to FIG. 5, it is assumed that there are a user having a wireless sensor 100 and a plurality of terminal devices 200(a first terminal device, a second terminal device, a third terminal device, . . . , and an n-th terminal device) around the user in the first embodiment of a signal processing method according to the present invention. In addition, a receiver 300 (a first receiver, a second receiver, a third receiver, . . . , and an n-th receiver) is installed in all of the terminal devices.

A user approaches the second terminal device among the terminal devices 200. That is, seeing the figure, the user moves from position ‘A’ to position ‘B’. Then, the user performs user authentication through the authentication unit 310 provided in the second receiver of the second terminal device.

The user may use an ID card or his or her own biometric information for the user authentication. When the user authentication is completed through the second receiver of the second terminal device in the method described above (when the terminal device is selected), the second terminal device is activated by the receiver controller 330 of the second receiver. At this point, the other terminal devices are forcibly deactivated since any authentication procedure is not performed.

Next, all terminal devices receive a sensor signal sensed by the wireless sensor 100. At this point, all the terminal devices, not a specific terminal device, will receive the sensor signal. However, not all the terminal devices output the sensor signal, but only the activated terminal device, e.g., the second terminal device, outputs the sensor signal. For example, in the case of health equipment, the second terminal device processes the sensor signal transmitted from the wireless sensor and displays the sensor signal on the screen of the display 220 or output the sensor signal through the speaker 230, and accordingly, the user may properly adjust the exercise amount while checking his or her health status in real-time. In addition, although the other terminal devices receive the sensor signal, they do not output the sensor signal through the display 220 or the speaker 230. That is, they do not output any sensor signal.

Like this, in the first embodiment, the second terminal device, which is a specific terminal for which the user performs an authentication procedure, is activated and outputs the sensor signal sensed by the wireless sensor 100, and although the other deactivated terminal devices receive the sensor signal, they do not output and ignore the sensor signal.

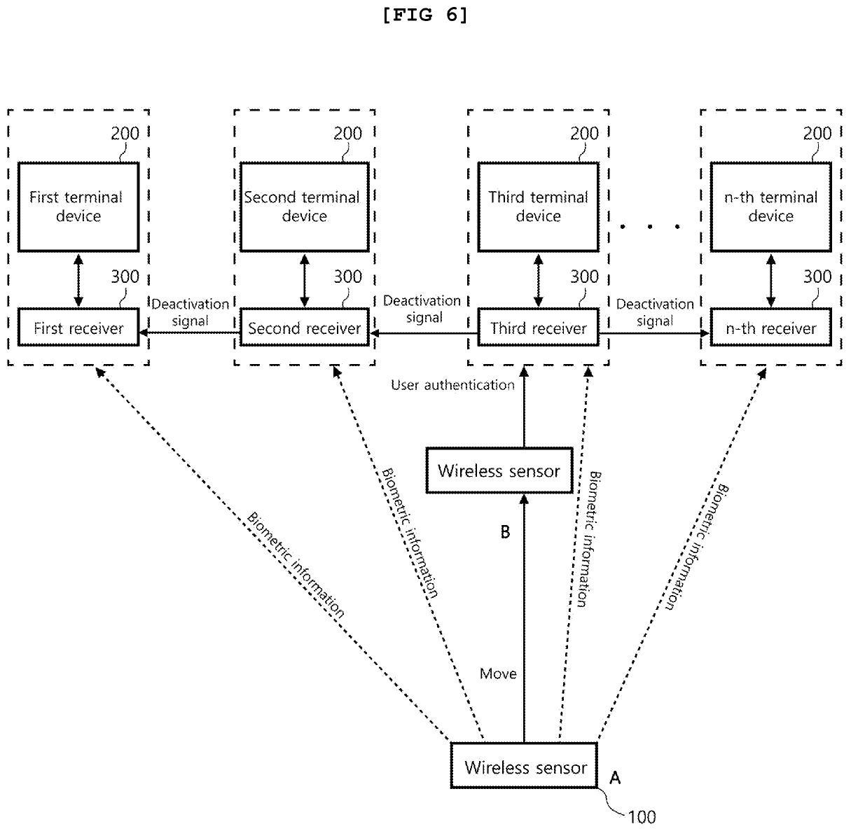

FIG. 6 is a view illustrating a second embodiment of a method of processing sensor signals by a sensor signal processing system of the present invention.

Referring to FIG. 6, the second embodiment is a method in which a specific terminal device is activated and outputs a sensor signal according to a degree of approach to the terminal device 200 by a user. For the second embodiment like this, the user should have a proximity sensor mounted thereon, and an approach sensing unit 311 should be provided in the receiver 300 of the terminal device 200.

As shown in the figure, it is assumed that there are a user having a proximity sensor and a wireless sensor 100, and a plurality of terminal device respectively equipped with a receiver and provided around the user.

The user wearing the proximity sensor moves from position A to position B. At this point, it is assumed that a third terminal device is closest to position B. The approach sensing unit 311 of the third receiver at the nearest distance when the user approaches receives an event signal recognizing that the user approaches, and accordingly, the third terminal device is activated.

Accordingly, only the activated third terminal device outputs the sensor signal received from the user. Of course, although the other terminal devices also receive the sensor signal, they are not in a state capable of outputting the sensor signal since they are in a deactivated state.

Deactivation of the other terminal devices is performed by the activated third terminal device. That is, the third terminal device activated according to approach of the user needs to inform the other terminal devices that the third terminal device itself is currently in the activated state, and deactivate the other terminal devices. That is, this is to prevent the other terminal devices from continuously maintaining a state of waiting for arrival of a sensor signal transmitted from the wireless sensor 100.

Accordingly, the third terminal device transmits a deactivation signal to the second terminal device or the n-th terminal device positioning nearest from the third terminal device itself to deactivate the terminal devices. Then, the second terminal device or the n-th terminal device switched to a deactivated state also transmits a deactivation signal to another terminal device positioned nearest from the second terminal device or the n-th terminal device itself to deactivate the terminal device. That is, a terminal device in an activated state sequentially sends a deactivation signal starting from a terminal device nearest from the terminal device itself and switches the terminal device to the deactivated state. At this point, a terminal device receiving the deactivation signal is switched to a deactivated state after transmitting the deactivation signal to another terminal device.

When a specific terminal device is activated like this, only the terminal device outputs the sensor signal, and the terminal devices deactivated by the deactivation signal do not output and ignore the received sensor signal.

Meanwhile, in FIG. 6, there may be two or more terminal devices within the range of approach of a proximity sensor when the user moves the position around the terminal devices. Although two or more terminal devices may be activated in this case, only one terminal device should be selected since the terminal device that the user desires to use should be practically one.

Accordingly, when the user approaches, a signal strength determination unit (not shown) of each receiver confirms signal strength of an event signal recognizing that the user has approached. Then, when the signal strength is higher than a predetermined reference value, each of the receivers activates its terminal device. As another example, a terminal device having the highest signal strength may be activated.

If it is assumed that the event signal sensed by the third terminal device is higher than the reference value as a result of confirming the signal strength as shown in the example described above, the third terminal device is activated. Accordingly, only the third terminal device may process the sensor signal received from the wireless sensor, and transmits a deactivation signal to other terminal devices to deactivate the terminal devices. At this point, the other terminal devices switched to the deactivated state cannot output the received sensor signal in any way.

Here, when the user moves in a direction leaving away from the third terminal device and goes out of the sensing range, the activated third terminal device is automatically deactivated, and any other terminal device may be activated.

Although a case of selecting and activating only one user terminal is described in the above example, the present invention may simultaneously select two or more terminal devices and execute the activation process.

In the present invention, a sensor signal should be assigned with an authentication message (or also referred to as a unique authentication code) for each user as described above. The reason of assigning the authentication message is to prevent a specific terminal device currently processing a sensor signal of a specific user from simultaneously processing a sensor signal transmitted from another user.

That is, a specific terminal device is activated according to an authentication procedure of a specific user. Then, the terminal device in the activated state processes and outputs a sensor signal sensed by a wireless sensor in the body of the user. At this point, if the terminal device in the activated state outputs a sensor signal of another user, the terminal device outputs the sensor signals of the current user and another user together, and in this case, the users themselves may not distinguish which one is their own signal. Or, since the sensor signals may not be processed simultaneously, there may be a situation in which any sensor signal cannot be processed.

In addition, various examples of the method of processing only the sensor signal of one user when a specific terminal device is activated as described above according to the present invention are described below.

For example, the terminal device control unit or the receiver control unit is programmed to ignore all sensor signals transmitted from the moment when a specific terminal device is activated by an event signal and the specific terminal device processes a sensor signal of a user who has generated the event signal. As another example, sensor signals having an authentication message other than a currently processed authentication message are ignored on the basis of the authentication message assigned to the sensor signal. In this way, practically only the sensor signal of one user is processed.

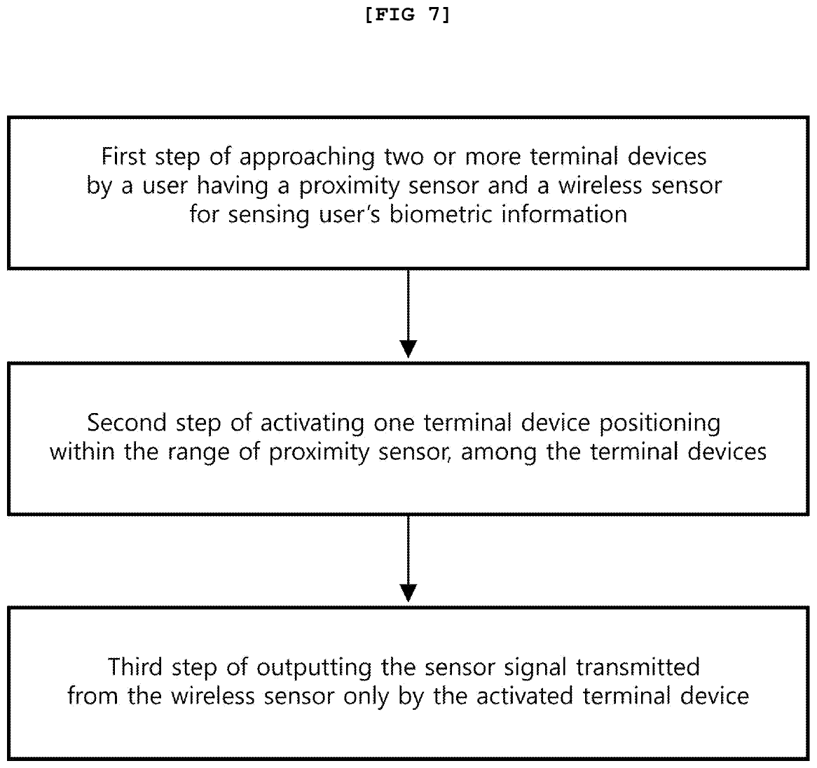

Therefore, as shown in FIG. 7, the methods of processing sensor signals according to a first embodiment and a second embodiment may be performed to include a first step of approaching a terminal device by a user having a wireless sensor for sensing biometric information of the user; a second step of activating the terminal device by performing user authentication through an authentication means provided in the terminal device; and a third step of processing a sensor signal transmitted from the wireless sensor by the activated terminal device, and as described above, the methods may be performed by adding the steps of deactivating a terminal device for which user authentication is not performed, processing only to receive and not to output a sensor signal by the terminal device in the deactivated state, and transmitting a deactivation signal to at least one other terminal device and deactivating the terminal device, by the activated terminal device.

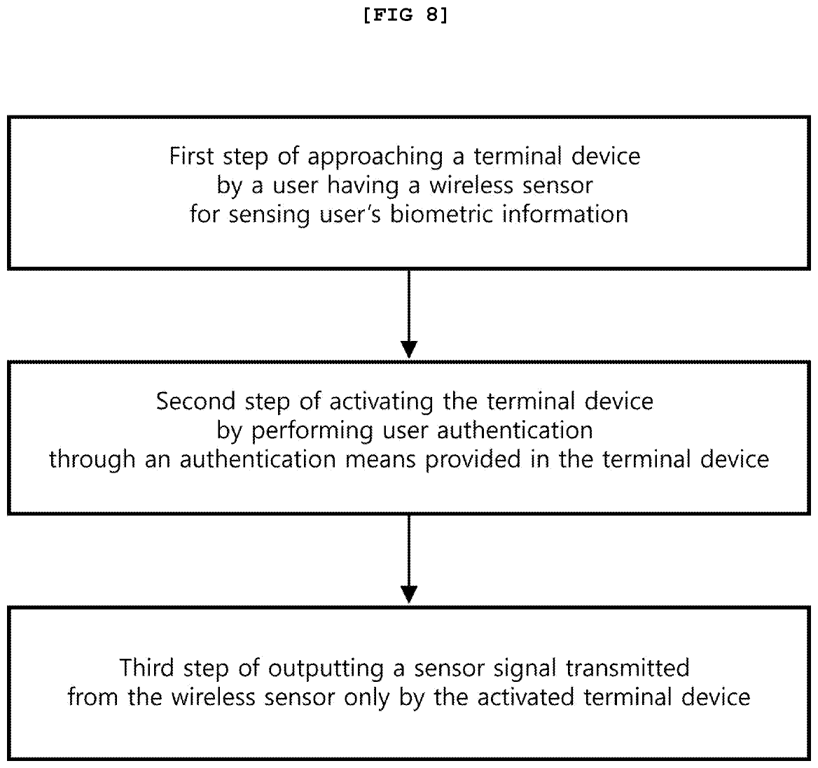

In addition, as shown in FIG. 8, the methods of processing sensor signals according to a first embodiment and a second embodiment may be performed to include a first step of approaching two or more terminal devices by a user having a proximity sensor and a wireless sensor for sensing biometric information of the user; a second step of activating a terminal device positioning within the range of the proximity sensor among the terminal devices; and a third step of outputting a sensor signal transmitted from the wireless sensor only by the activated terminal device. When there are two or more terminal devices positioning within the range of the proximity sensor at the second step, a terminal device having a signal strength higher than a predetermined reference value or a terminal device having a highest signal strength is activated according to the signal strength of the proximity sensor. The second step further includes a deactivation step of transmitting a deactivation signal to another terminal device and deactivating the terminal device by the activated terminal device, and the deactivation step may sequentially perform the steps of transmitting a deactivation signal to at least one other nearest terminal device by the activated terminal device, transmitting a deactivation signal to at least one other terminal device near the terminal device by the one other terminal device, and switching the terminal devices to a deactivated state after transmitting the deactivation signal.

In addition, the terminal device in an activated state operates to switch to a deactivated state when the terminal device goes out of the sensing range of the proximity sensor according to movement of the user, and at the third step, the deactivated terminal device may be processed only to receive and not to output the sensor signal.

Although the present invention has been described with reference to the embodiments shown in the drawings, this is only an example, and those skilled in the art may clearly understand that various modifications, changes and other equivalent embodiments can be made without departing from the spirit and scope of the present invention. Accordingly, the true scope of the present invention will be defined by the spirit of the attached claims.

### DESCRIPTION OF SYMBOLS

100: Wireless sensor
110: Transmission unit 120: Sensing unit
200: Terminal device
210: Terminal device control unit
220: Display 230: Speaker
240: Keypad 300: Receiver
310: Authentication unit 311: Approach sensing unit
320: Reception unit 330: Receiver control unit
340: Signal transmission unit 350: Mode switch

1. A wireless sensor signal processing system comprising:
a plurality of wireless sensors for simultaneously transmitting a sensor signal sensing a measurement target to two or more terminal devices within a transmission range in the same protocol to allow simultaneous channel switch; and
the two or more terminal devices for simultaneously receiving the sensor signal, processing and outputting the sensor signal only in an activated state, and not outputting the received sensor signal in a deactivated state, wherein
activation and deactivation of the terminal devices is performed according to information on approach of a user to the terminal devices or an event signal generated by a user authentication means.

2. The system according to claim 1, wherein the wireless sensor includes:
a sensing unit for sensing information on the measurement target; and
a control unit for controlling the wireless sensor to transmit the sensed sensor signal to a terminal device within the transmission range, wherein
the sensor signal includes an authentication message and a wireless sensor data.

3. The system according to claim 2, wherein the terminal device includes a receiver for receiving the sensor signal, wherein
the receiver receives the event signal and activates the terminal device only when an authentication procedure of the receiver is passed.

4. The system according to claim 3, wherein the receiver includes:
an approach sensing unit for sensing whether a user approaches;
an authentication unit for authenticating the user;
a sensor signal reception unit for receiving the sensor signal; and
a receiver control unit for controlling the receiver to output the sensor signal only when the terminal device is in an activated state according to a processing result of the approach sensing unit or the authentication unit.

5. The system according to claim 4, wherein the receiver further includes a signal transmission unit for transmitting a deactivation signal to another terminal device by the activated terminal device.

6. The system according to claim 1, wherein the terminal device includes:
an approach sensing unit for sensing whether a user approaches;
an authentication unit for authenticating the user;
a sensor signal reception unit for receiving the sensor signal;
a receiver control unit for controlling the terminal device to process and output the sensor signal only when the terminal device is in an activated state according to a processing result of the approach sensing unit or the authentication unit; and
a signal transmission unit for transmitting a deactivation signal to another terminal devices.

7. The system according to claim 6, wherein the terminal device is a smart device for receiving and displaying biometric information, and the smart device is any one selected among fitness equipment, office equipment, a device for clinic systems, an Internet of Things (IoT) device, an industrial system operated by battery power, a sensor of a wearable form, a device for transmitting information, and a biosensor operating only by bioenergy.

8. The system according to claim 3, wherein the terminal device in an activated state processes only the sensor signal transmitted from the wireless sensor of a specific user on the basis of an authentication message included in the sensor signal and does not simultaneously process sensor signals of two or more users.

9. A wireless sensor signal processing method comprising:
a first step of simultaneously transmitting sensor signals sensed by a plurality of wireless sensors for sensing a measurement target to two or more terminal devices in the same protocol;
a second step of simultaneously receiving the sensor signals and activating any one of the terminal devices, by the two or more terminal devices; and
a third step of processing and outputting the sensor signal transmitted from the wireless sensor by only the activated terminal device, and only receiving and not outputting the sensor signal by the other terminal devices in a deactivated state.

10. The method according to claim 9, wherein in the second step, according to a signal strength of a proximity sensor installed in the wireless sensor, a terminal device having a signal strength larger than a previously set reference value or a terminal device having a highest signal of the proximity sensor is activated, or only a terminal device having performed user authentication through an authentication means of the terminal device is activated.

11. The method according to claim 10, wherein the second step further includes a deactivation step of transmitting a deactivation signal to another terminal device and deactivating the terminal devices by the activated terminal device, wherein
the deactivation step sequentially performs the steps of transmitting a deactivation signal to at least one other nearest terminal device by the activated terminal device, transmitting a deactivation signal to at least one other terminal device near the terminal device by the one other terminal device, and switching the terminal devices to a deactivated state after transmitting the deactivation signal.

12. The method according to claim 11, wherein the activated terminal device is switched to a deactivated state when the activated terminal device goes out of a sensing range of the proximity sensor according to movement of the user.

13. The system according to claim 6, wherein the terminal device in an activated state processes only the sensor signal transmitted from the wireless sensor of a specific user on the basis of an authentication message included in the sensor signal and does not simultaneously process sensor signals of two or more users.
